(19) United States
(12) Patent Application Publication
(10) Pub. No.: US 2017/0276292 A1
(43) Pub. Date: Sep. 28, 2017

(54) TILT PREVENTION STRUCTURE FOR TEST SEAT

(71) Applicant: GIGA SOLUTION TECHNOLOGY CO., LTD., Hsinchu (TW)

(72) Inventors: YU-CHUAN CHU, Hsinchu (TW); LIANG-PO CHEN, Hsinchu (TW)

(21) Appl. No.: 15/076,663

(22) Filed: Mar. 22, 2016

(51) Int. Cl. F16M 13/02; B25B 11/00

(52) U.S. Cl. CPC F16M 13/022; B25B 11/00

(57) ABSTRACT

The tilt prevention structure for a test seat contains a track element having at least a notch configured on a top side of the track element, a base member having a trough on a bottom side for detachably accommodating the track element and at least a fastening hole on a front side connecting the trough, and at least a limiting element plugged into the fastening hole. The track element is fixedly configured on a test apparatus. The base member is then joined to the track element by embedding the track element in the trough. The limiting elements are plugged into the fastening holes so as to prevent the base member from tilting. The base member can be moved along the track element so as to align the adjustment member against an object to be tested.

### BACKGROUND OF THE INVENTION

(a) Technical Field of the Invention

The present invention is generally related to test seats, and more particular to a tilt prevention structure for a test seat.

(b) Description of the Prior Art

A production line has a specific process running sequentially through a number of workstations. If a work in progress (WIP) is delayed at a workstation, the subsequent workstations will be idle and the process has to be speeded up afterwards.

A test seat in the above production process is a device designed to hold the WIP under test in place and allow it to be tested by other test apparatus. In order to hold the WIP reliably, a conventional test seat has to be fixedly positioned. Since the test seat has a certain weight and length, usually an operator has to hold the test seat with one hand and position the test seat with the other hand, so as to prevent the test seat from tilting and damaging the WIP. This is a time consuming work, especially when a fastening location such as a bolt hole has to be located in positioning the test seat.

### SUMMARY OF THE INVENTION

A major objective of the present invention therefore is to prevent the test seat and the WIP from tilting and damaging.

Another major objective of the present invention is to facilitate the mounting and dismounting of the test seat.

To achieve the objective, the disclosed tilt prevention structure for a test seat contains a track element having at least a notch configured on a top side of the track element, a base member having a trough on a bottom side for detachably accommodating the track element and at least a fastening hole on a front side connecting the trough, and at least a limiting element plugged into the fastening hole. The track element is fixedly configured on a test apparatus. The base member is then joined to the track element by embedding the track element in the trough. The limiting elements are plugged into the fastening holes so as to prevent the base member from tilting. The base member can be moved along the track element so as to align the adjustment member against an object to be tested. As such, the prior art's various problems are obviated.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective diagram showing a tilt prevention structure for a test seat according to an embodiment of the present invention.

FIG. 2 is a perspective break-down diagram showing the tilt prevention structure of FIG. 1.

FIG. 3 is a perspective diagram showing a first step of assembling the tilt prevention structure of FIG. 1.

FIG. 4 is a perspective diagram showing a second step of assembling the tilt prevention structure of FIG. 1.

FIG. 5 is a schematic top-view diagram showing a third step of assembling the tilt prevention structure of FIG. 1.

FIG. 6 is a perspective diagram showing a fourth step of assembling the tilt prevention structure of FIG. 1.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

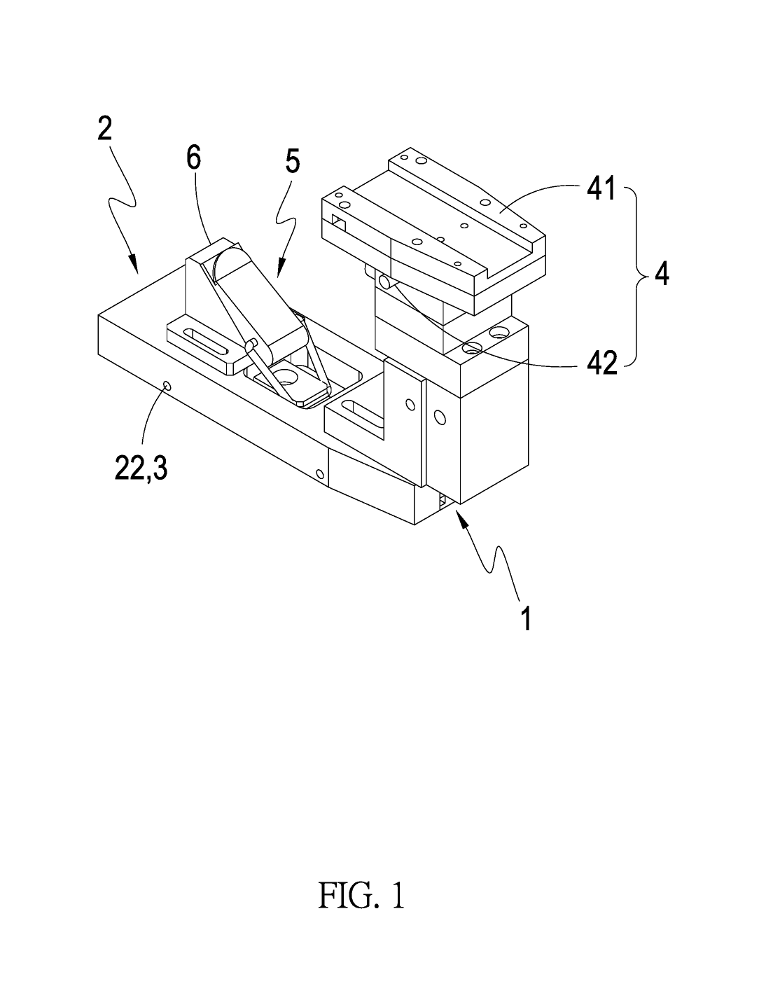

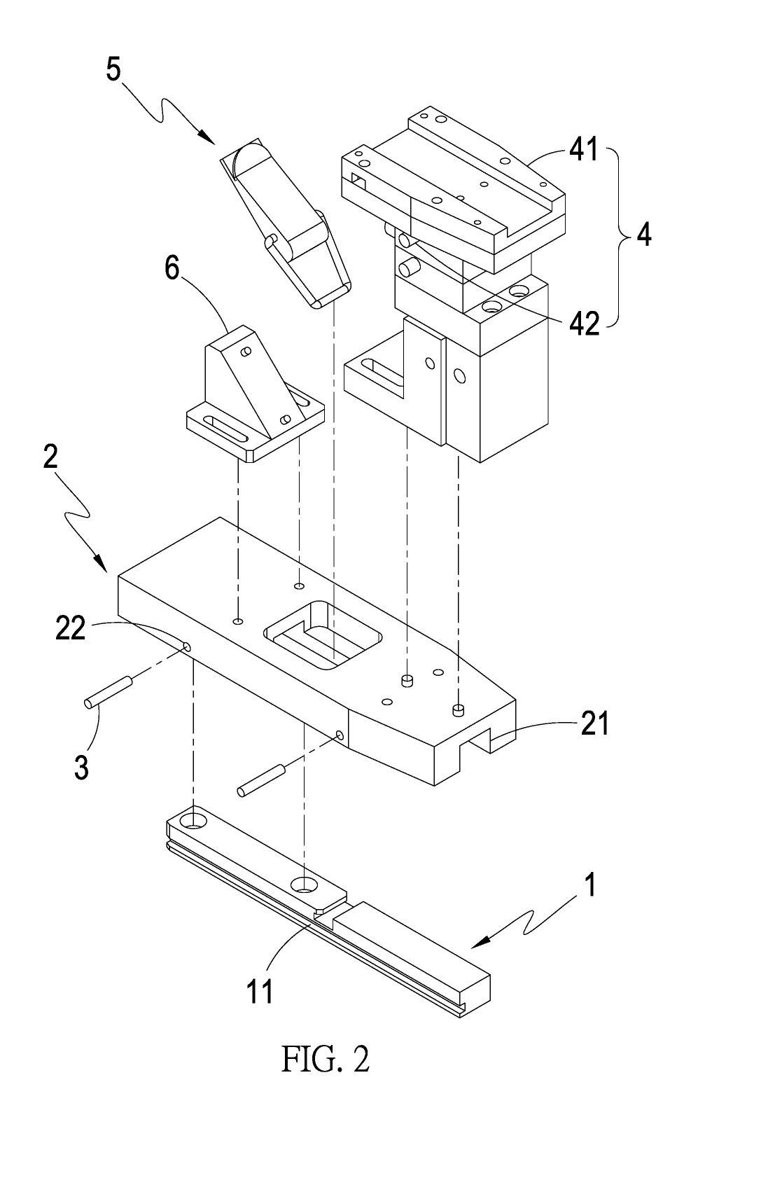

As shown in FIGS. 1 and 2, a tilt prevention structure for a test seat according to an embodiment of the present invention contains an elongated track element 1 and a base member 2. The track element 1 is fixedly configured on a test apparatus (not shown). The track element 1 has at least a notch 11 configured on a top side of the track element 1 perpendicular to an axial direction of the track element 1. The base member 2 has an elongated trough 21 along the axial direction on a bottom side so as to detachably accommodate the track element 1. The trough 21 is configured so that the bottom side of the base member 2 is able to contact the test apparatus. The base member 2 further has at least a fastening hole 22 on a front side running perpendicularly and connecting the trough 21. The tilt prevention structure further contains a number of limiting elements 3 plugged into the fastening holes 22 so as to prevent the base member 2 from tilting.

The tilt prevention structure further contains at least an adjustment member 4 configured on a top side of the base member 2 opposite to the bottom side and adjacent to a lateral side of the base member 2. Each adjustment member 4 contains an adjustment platform 41 and at least an adjustment pin 42 to a lateral side of the adjustment platform 41 for positioning the adjustment platform 41. The tilt prevention structure further contains a fastener seat 6 and a fastener element 5. The fastener seat 6 is configured on the top side adjacent to another lateral side of the base member 2. Between the fastener seat 6 and the adjustment member 4, the base member 2 has a through channel (not numbered) exposing the notch 11 of the track element 1. The fastener element 5 is positioned on the fastener seat 6 and engages the notch 11 via the through channel.

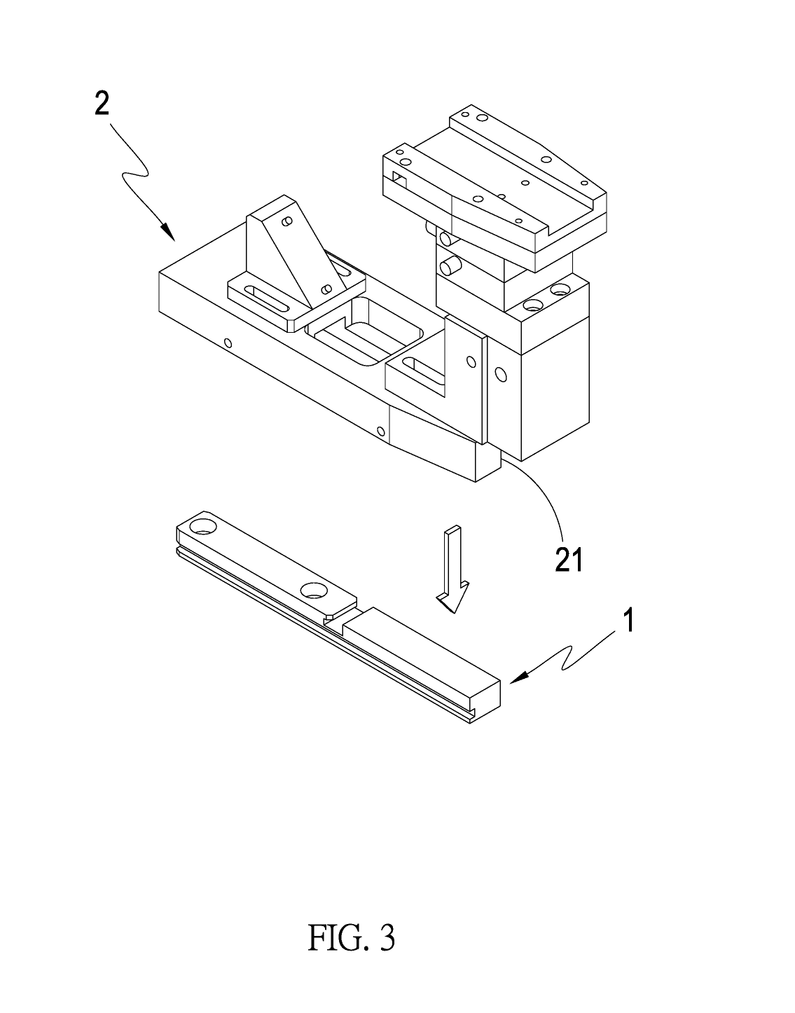

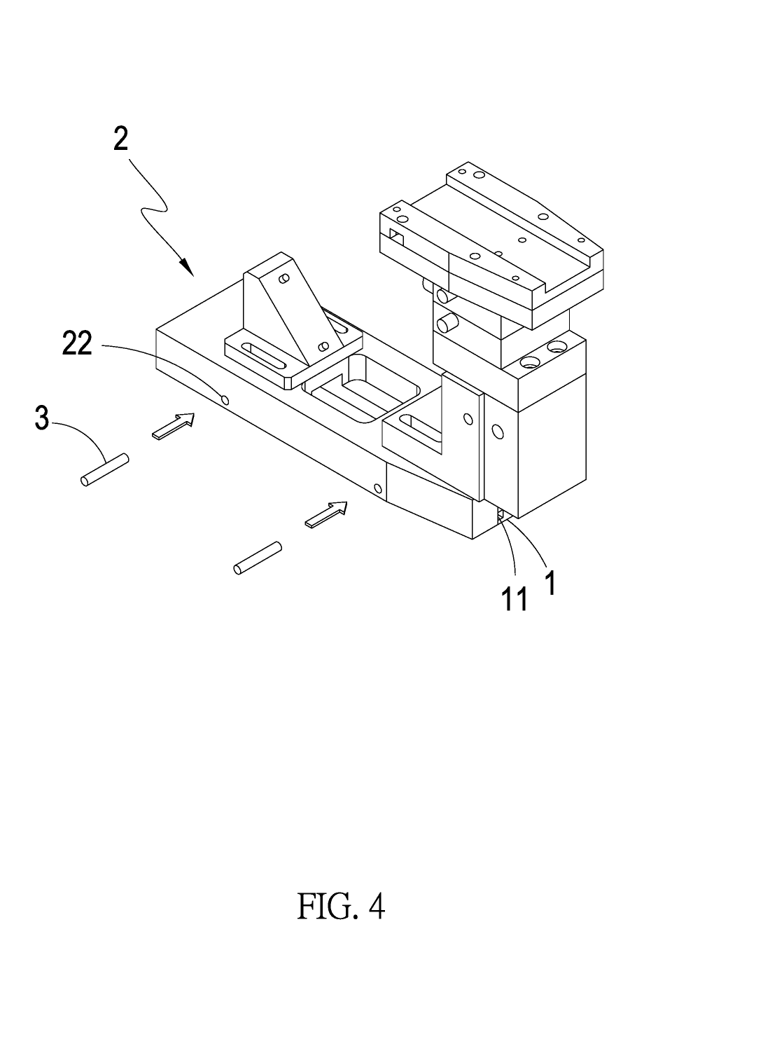

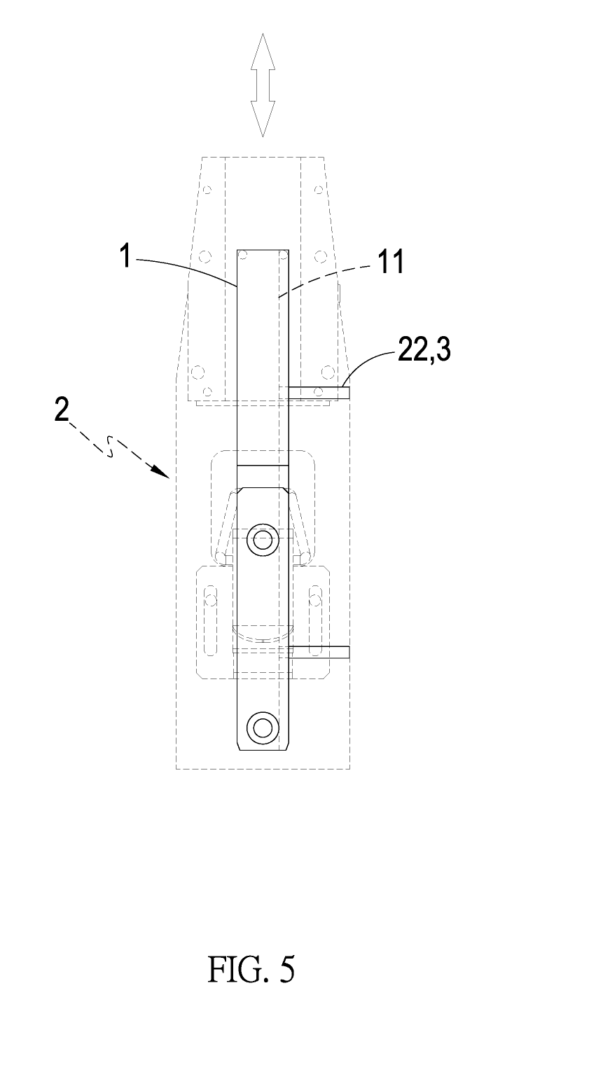

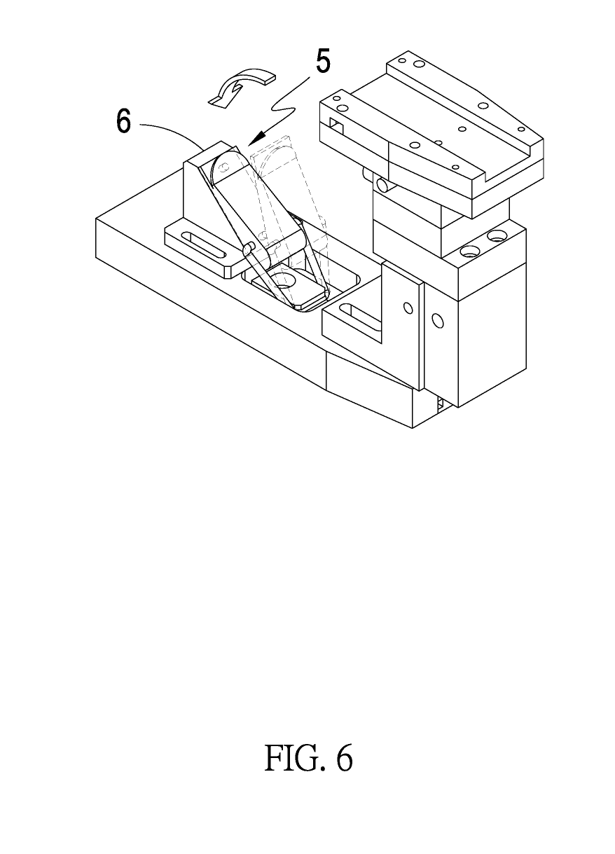

As shown in FIGS. 3 to 6, to assemble the tilt prevention structure, the adjustment member 4 is joined to the base member 2 and the track element 1 is fixedly configured on the test apparatus (not shown) to facilitate subsequent assembly and test. The base member 2 is then joined to the track element 1 by embedding the track element 1 in the trough 21. The bottom side of the base member 2 contacts with the test apparatus. The limiting elements 3 are plugged into the fastening holes 22 so that the base member 2 is locked to the track element 1. The base member 2 therefore can only move along the track element 1 in the axial direction so as to prevent the base member 2 from being tilted perpendicularly to the axial direction.

By moving the base member 2, an operator is able to align the adjustment member 4 against the WIP to be tested without worrying the base member 2 is tilted and therefore without holding the base member 2 all the time.

Finally, an operator can easily configure the fastener element 5 on the fastener seat 6 and lock the fastener element 5 to the notch 11 of the track element 1.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

I claim:

1. A tilt prevention structure for a test seat comprising:
a track element having at least a notch configured on a top side of the track element;
a base member having a trough on a bottom side for accommodating the track element, and at least a fastening hole on a front side running perpendicularly and connecting the trough; and
at least a limiting element plugged into the fastening hole so as to prevent the base member from tilting.

2. The tilt prevention structure according to claim 1, wherein the track element is fixedly configured on a test apparatus; and the bottom side of the base member contacts the test apparatus.

3. The tilt prevention structure according to claim 1, wherein the notch and the fastening hole are along a direction intersecting an axial direction of the track element and the trough.

4. The tilt prevention structure according to claim 1, wherein the notch and the fastening hole are along a direction perpendicular to an axial direction of the track element and the trough.

5. The tilt prevention structure according to claim 1, wherein the base member and the track element are detachably joined together by the limiting element.

6. The tilt prevention structure according to claim 1, further comprising an adjustment member configured on a top side opposite to the bottom side and adjacent to a first lateral side of the base member.

7. The tilt prevention structure according to claim 6, wherein the adjustment member comprises an adjustment platform and at least an adjustment pin to a lateral side of the adjustment platform for positioning the adjustment platform.

8. The tilt prevention structure according to claim 1, further comprising a fastener element engaging the notch of the track element via a through channel in a central section of the base member.

9. The tilt prevention structure according to claim 8, further comprising a fastener seat configured on a top side and adjacent to a second lateral side of the base member; and the fastener element is configured on the fastener seat.
